(19) United States
(12) Patent Application Publication
(10) Pub. No.: US 2012/0099705 A1
(43) Pub. Date: Apr. 26, 2012

(54) RADIOGRAPHIC APPARATUS AND RADIOGRAPHIC SYSTEM

(75) Inventors: Dai MURAKOSHI, Kanagawa (JP); Masanori SASAO, Kanagawa (JP)

(73) Assignee: FUJIFILM CORPORATION, Tokyo (JP)

(21) Appl. No.: 13/282,087

(22) Filed: Oct. 26, 2011

(30) Foreign Application Priority Data
Oct. 26, 2010 (JP) 2010-240186

(51) Int. Cl. G21K 1/06

(52) U.S. Cl. 378/85

(57) ABSTRACT

A radiographic apparatus includes a guide housing, a first grating unit, a radiological image detector and a grating pattern unit. The guide housing houses a first grating unit, the grating pattern unit, and a radiological image detector and supports a subject to which radiation is irradiated. The grating pattern unit includes a periodic form having a period and masks a radiological image formed by the radiation having passed through the first grating. The radiological image detector detects a masked radiological image which is formed by masking the radiological image by the grating pattern unit. The first grating unit and the grating pattern unit are supported by the guide housing with a buffer material being interposed between the first grating unit and the grating pattern unit and an inner wall of the guide housing.

### CROSS-REFERENCE TO RELATED APPLICATIONS

This application claims the benefit of Japanese Patent Application No. 2010-240186 (filed on Oct. 26, 2010), the entire contents of which are hereby incorporated by reference.

### BACKGROUND

1. Technical Field

The invention relates to a radiographic apparatus and a radiographic system enabling a phase imaging of a subject by using radiation such as X-ray.

2. Related Art

Since X-ray attenuates depending on an atomic number of an element configuring a material and a density and a thickness of the material, it is used as a probe for seeing through an inside of an object to be diagnosed. An imaging using the X-ray is widely spread in fields of medical diagnosis, nondestructive inspection and the like.

In a general X-ray imaging system, an object to be diagnosed is arranged between an X-ray source that irradiates the X-ray and an X-ray image detector that detects the X-ray and a transmission image of the object to be diagnosed is captured. In this case, the X-ray irradiated from the X-ray source toward the X-ray image detector is subject to the attenuation (absorption) depending on differences of the material properties (for example, atomic numbers, densities and thickness) existing on a path to the X-ray image detector and is then incident onto each pixel of the X-ray image detector. As a result, an X-ray absorption image of the object to be diagnosed is detected and captured by the X-ray image detector. As the X-ray image detector, a flat panel detector (FPD) is widely used in addition to a combination of an X-ray intensifying screen and a film and a photostimulable phosphor.

However, the X-ray absorption ability is reduced in case of the material consisting of the element having the smaller atomic number. Accordingly, for soft biological tissue or soft material, it is not possible to obtain the sufficient contrast of an image for the X-ray absorption contrast image. For example, the articular cartilage and synovial fluid configuring an articulation of the body are mostly comprised of water. Thus, since a difference of the X-ray absorption amounts thereof is small, it is difficult to obtain the sufficient contrast of the image.

Regarding the above problem, instead of the intensity change of the X-ray through the object to be diagnosed, a research on an X-ray phase contrast imaging of obtaining an image (hereinafter, referred to as a phase contrast image) based on a phase shift of the X-ray wave front caused by the difference in refraction index of the object to be diagnosed has been actively carried out in recent years. In general, it has been known that when the X-ray is incident onto an object, the phase of the X-ray wave front, rather than the intensity of the X-ray, shows the higher interaction. Accordingly, in the X-ray phase contrast imaging of using the phase difference, it is possible to obtain a high contrast image even for a weak absorption material having low X-ray absorption ability. As the X-ray phase contrast imaging, an X-ray imaging system has been recently suggested which uses an X-ray Talbot interferometer having two transmission diffraction gratings (phase type grating and absorption type grating) and an X-ray image detector (for example, refer to JP-A-2008-200359).

The X-ray Talbot interferometer includes a first diffraction grating (phase type grating or absorption type grating) that is arranged at a rear side of an object to be diagnosed, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase shift) with the object to be diagnosed, which is arranged between the X-ray source and the first diffraction grating, and the X-ray.

In the X-ray Talbot interferometer, a moiré fringe that is generated by superposition (intensity modulation) between the self-image of the first diffraction grating and the second diffraction grating is detected and a change of the moiré fringe by the object to be diagnosed is analyzed, so that phase information of the object to be diagnosed is acquired. As the analysis method of the moiré fringe, a fringe scanning method has been known. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating extending direction of the first diffraction grating, with a scanning pitch that is obtained by equally partitioning the grating pitch, and an angular distribution (differential phase image) of the X-ray refracted from the object to be diagnosed is acquired from changes of respective pixels obtained in the X-ray image detector. Based on the angular distribution, it is possible to acquire a phase contrast image of the object to be diagnosed.

A refraction angle of the X-ray passing through the subject is very small such as a few μrad and a phase shift amount of a radiological image resulting from the refraction angle, i.e., a signal change amount of each pixel is also very small. Furthermore, the signal change amount of each pixel can be obtained by performing a plurality of imaging while shifting the relative position of the first and second gratings by one period of a slit interval of the grating. The relative moving amount of the first and second gratings is small when performing the plurality of imaging. Hence, for example, when the external force or vibration is applied to a platform supporting the object to be diagnosed and the relative position of the first and second gratings is thus deviated even slightly, the detection accuracy of the phase information by an imaging unit consisting of the first and second gratings and the radiological image detector may be seriously influenced. That is, the relative position of the first and second gratings, the respective relative positions of the focus of the radiation and the first and second gratings, and the like are very important.

As the measures against the vibration and the like, in JP-A-2008-200359, a holding structure for holding the first and second gratings and a platform for the subject are separately configured and the holding structure is supported to a support member that supports the entire imaging apparatus via a buffer material.

Here, like JP-A-2008-200359, when the holding structure for holding the first and second gratings and the platform for the subject are separately configured, an interval between the subject and the first grating and an interval between the subject and the radiological image detector are increased, so that an image of the subject is enlarged. Accordingly, compared to a configuration in which the platform for the subject, the first and second gratings and the radiological image detector are integrated, an imaging region of the subject is limited. In order to cope with the problem, the gratings or radiological image detector may be enlarged. However, as the apparatus is large-sized, the handling capability of the X-ray imaging apparatus is deteriorated in addition to problems of the manufacturing technology and the cost. Furthermore, like JP-A-2008-200359, when the holding structure for the first and second gratings and the platform for the subject are separately configured, the first and second gratings may be vibrated by the external force directly applied to the first and second gratings, which may exert a bad influence on the quality of the phase contrast image.

For example, a relative relation between the grating period (pitch) of each of the first and second gratings and the slit interval is geometrically determined by distances (distances in a Z direction) between the X-ray focus and the respective first and second gratings. Accordingly, when the distances between the X-ray focus and the respective first and second gratings are relatively deviated by the vibration and the like, an image magnification factor is changed, so that the pitch of the second grating relative to the pitch of the radiological image incident onto the second grating is relatively deviated and thus the moiré of a spatial frequency resulting from the deviation is generated. The moiré on an image can be typically corrected to a degree of not causing a problem on the image by using a separately acquired image just before or after the imaging or performing a preferred filtering process. However, it is very difficult to correct the moiré whose spatial frequency is changed in correspondence to the relative deviation amount of the X-ray focus and each grating. As a result, the quality of the phase contrast image is deteriorated.

Also, like JP-A-2008-200359, when the holding structure is cantilever-supported in an in-plane direction perpendicular to the gravity direction via the buffer material, the first and second gratings are apt to be inclined with respect to design-determined grating surfaces and the relative position of each of the first and second gratings to the X-ray focus may be easily deviated. In particular, the deviation is noticeable at a free end, so that the quality of the phase contrast image is deteriorated.

In addition, when the first grating is deviated in an arrangement direction (x direction) of the grating slits with respect to the focus, the radiological image that is formed by the radiation having passed through the first grating blurs at a position at which the radiation is incident onto the second grating. Accordingly, the contrast of the intensity change detected in the radiological image detector is lowered, so that the quality of the phase contrast image is deteriorated.

Considering the above problems, an object of the invention is to provide a radiographic apparatus and a radiographic system capable of sufficiently suppressing a relative position deviation of first and second gratings and enabling an imaging of a favorable phase contrast image without enlarging the apparatus. SUMMARY OF INVENTION
[1] According to an aspect of the invention, a radiographic apparatus includes a guide housing, a first grating unit, a radiological image detector and a grating pattern unit. The guide housing houses a first grating unit, the grating pattern unit, and a radiological image detector and supports a subject to which radiation is irradiated. The grating pattern unit includes a periodic form that has a period and masks a radiological image formed by the radiation having passed through the first grating. The radiological image detector detects a masked radiological image which is formed by masking the radiological image by the grating pattern unit. The first grating unit and the grating pattern unit are supported by the guide housing with a buffer material being interposed between the first grating unit and the grating pattern unit and an inner wall of the guide housing.
[2] A radiographic system includes the radiographic apparatus of [1] and a calculation processing unit that calculates, from an image detected by the radiological image detector of the radiographic apparatus, a distribution of refraction angles of the radiation incident onto the radiological image detector and generates a phase contrast image of a subject based on the distribution of the refraction angles.

According to the radiographic apparatus and the radiographic system, the imaging unit (which includes the first and second gratings and the radiological image detector) is integrally accommodated in the guide housing of the subject and the first grating and the grating pattern are supported to the guide housing by the buffer material, so that it is possible to shorten the interval between the subject and the imaging unit. Accordingly, it is possible to make the radiographic apparatus compact. Furthermore, the imaging unit is accommodated in the guide housing and the first and second gratings or the holding structure for holding the gratings are supported to the guide housing via the buffer material, so that it is possible to block the external force and vibration from being transferred from the guide housing to the first and second gratings and to prevent the external force from being directly applied to the first and second gratings. Accordingly, the respective relative positions of the X-ray focus and the first and second gratings are suppressed from being deviated, so that it is possible to suppress the quality of the phase contrast image from being lowered due to the vibration and the like and to capture a favorable phase contrast image. Furthermore, the imaging unit is accommodated in the guide housing and the first and second gratings or the holding structure for holding the gratings are supported to the guide housing via the buffer material, so that it is possible to suppress the respective relative positions of the radiation focus and the first and second gratings from being deviated, which is caused due to inclination of the first and second gratings or the holding structure for holding the gratings by a cantilever. Therefore, it is possible to suppress the quality of the phase contrast image from being deteriorated and to capture a favorable phase contrast image.

### BRIEF DESCRIPTION OF THE DRAWINGS

FIG. 1 is a side view pictorially showing a configuration of a radiographic system for illustrating an illustrative embodiment of the invention.

FIG. 2 is a control block diagram of the radiographic system of FIG. 1.

FIG. 3 is a pictorial view showing a configuration of a radiological image detector by using blocks.

FIG. 4 is a perspective view of a grating unit housing to which buffer materials are provided.

FIG. 5 is a perspective view of first and second gratings and the radiological image detector.

FIG. 6 is a side view of the first and second gratings and the radiological image detector.

FIGS. 7A to 7C are pictorial views for showing a mechanism for changing a period of an interference fringe (moiré) resulting from an interaction of the first and second gratings.

FIG. 8 is a pictorial view for illustrating refraction of the radiation by a subject.

FIG. 9 is a pictorial view for illustrating a fringe scanning method.

FIG. 10 is a graph showing a pixel signal of the radiological image detector in accordance with the fringe scanning.

FIG. 11 is a pictorial view showing another example of a configuration of a radiographic system for illustrating an illustrative embodiment of the invention.

FIG. 12 is a perspective view of a grating unit housing to which buffer materials are provided.

FIG. 13 is a side view pictorially showing another example of a configuration of a radiographic system for illustrating an illustrative embodiment of the invention.

FIG. 14 is a side view pictorially showing another example of a configuration of a radiographic system for illustrating an illustrative embodiment of the invention.

FIGS. 15A and 15B are side views pictorially showing another example of a configuration of a radiographic system for illustrating an illustrative embodiment of the invention.

FIG. 16 is a side view pictorially showing another example of a configuration of a radiographic system for illustrating an illustrative embodiment of the invention.

FIG. 17 is a side view pictorially showing another example of a configuration of a radiographic system for illustrating an illustrative embodiment of the invention.

FIG. 18 is a block diagram showing a configuration of a calculation unit that generates a radiological image, in accordance with another example of a radiographic system for illustrating an illustrative embodiment of the invention.

FIG. 19 is a graph showing pixel signals of a radiological image detector for illustrating a process in the calculation unit of the radiographic system shown in FIG. 18.

### DETAILED DESCRIPTION

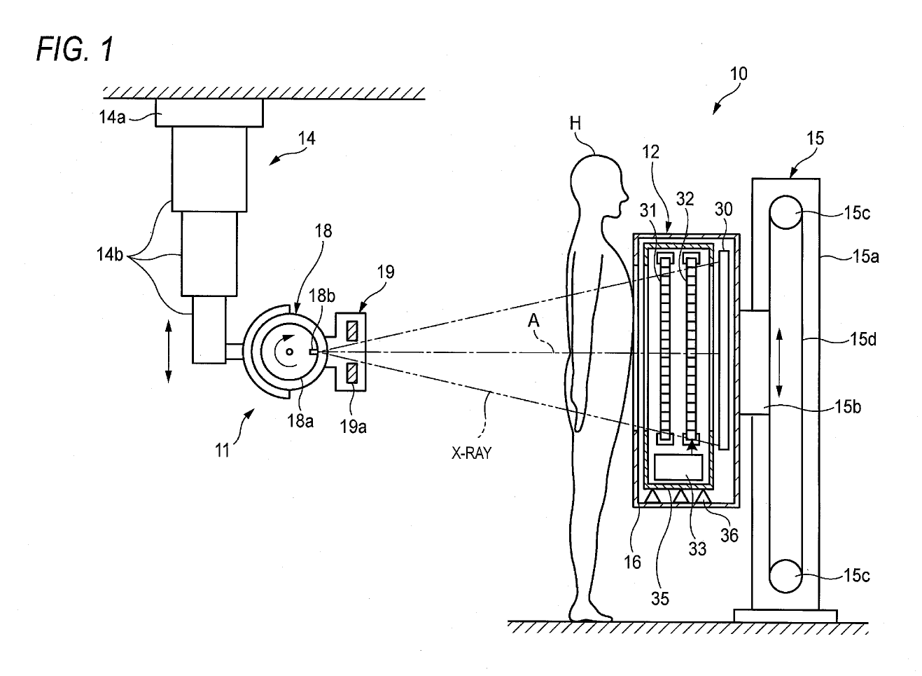

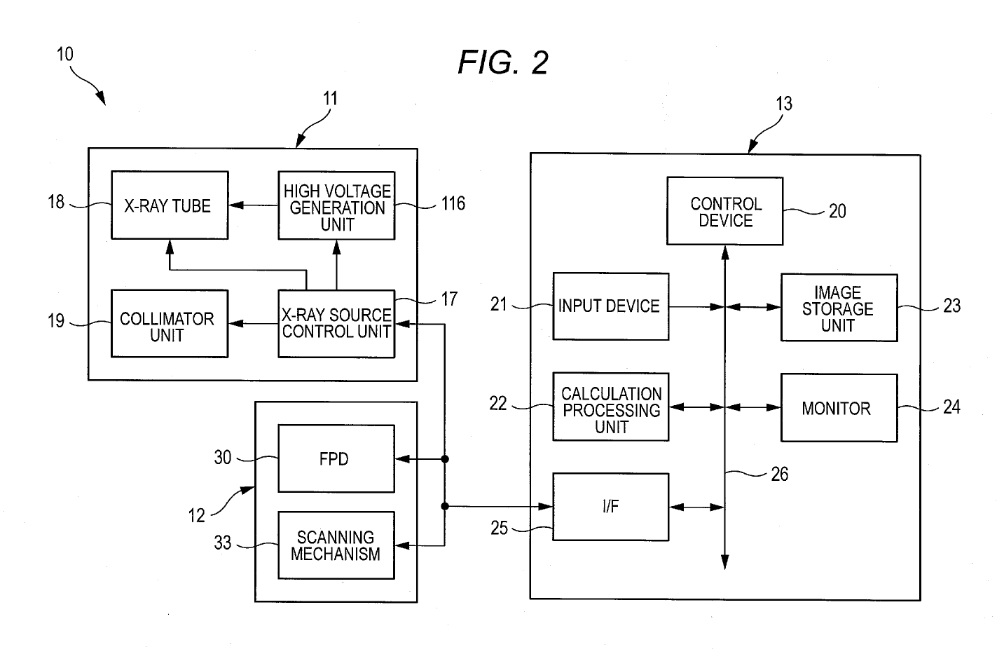

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging for a subject (patient) H while the patient stands, and includes an X-ray source 11 that radiates the subject H, a guide housing 16 that has a contact member contacting the subject H and supports the subject H, an imaging unit 12 that is opposed to the X-ray source 11 with the subject H being interposed between the X-ray source 11 and the imaging unit, detects the X-ray having penetrated the subject H from the X-ray source 11 and thus generates image data and a console 13 (refer to FIG. 2) that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling.

The guide housing 16 is held that it can be moved in the upper-lower direction by an upright stand 15 mounted on the bottom.

The X-ray source 11 includes an X-ray tube 18 that generates the X-ray in correspondence to a high voltage applied to a high voltage generator 116, based on control of an X-ray source control unit 17 and a collimator unit 19 having a moveable collimator 19a that limits a radiation field so as to shield a part of the X-ray generated from the X-ray tube 18, which part does not contribute to an inspection area of the subject H. The X-ray tube 18 is a rotary anode type X-ray tube that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b.

The X-ray source holding apparatus 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the guide housing 16 and is attached to the main body 15a so as to move in the upper-lower direction. The holding unit 15b is connected to an endless belt 15d that extends between two pulleys 15c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the guide housing 16 in the upper-lower direction. The detected value of the position sensor is supplied to the X-ray source holding device 14 through a cable and the like. The X-ray source holding device 14 expands and contracts the struts 14b, based on the detected value, and moves the X-ray source 11 to follow the vertical moving of the guide housing 16.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray radiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that serves as a radiological image detector having a semiconductor circuit, and a first absorption type grating 31 and a second absorption type grating 32 that detect a phase shift of the X-ray wave front caused by the difference in refraction index of the subject H and performs a phase contrast imaging. The first and second absorption type gratings 31, 32 are assembled and accommodated in a same grating unit housing 25 with overlapping in a direction following an optical axis A of the X-ray and defined with respect to a relative position to each other and are fixed in the grating unit housing 35. The grating unit housing 35 and the FPD 30 are accommodated in the guide housing 16. Also, in addition to the first and second gratings 31, 32, the FPD 30 may be accommodated in the grating unit housing 35.

The grating unit housing 35 is provided with a scanning mechanism 33 serving as a scanning means that translation-moves the second absorption type grating 32 in the upper-lower direction (x direction) and thus changes a relative position relation of the second absorption type grating 32 to the first absorption type grating 31. The scanning mechanism 33 is configured by an actuator such as piezoelectric device and the like, for example.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

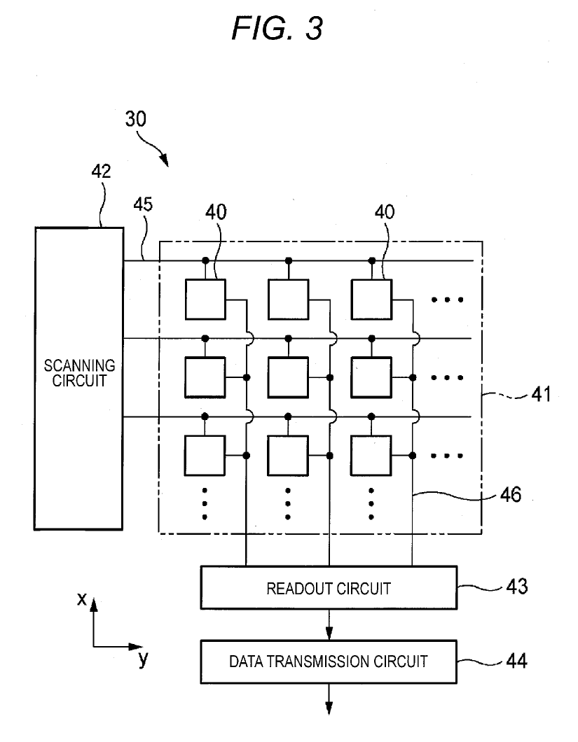

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

In addition, each pixel 40 may be also configured as an indirect conversion type X-ray detection element that converts the X-ray into visible light with a scintillator (not shown) made of Terbium-activated Gadolinium oxysulfide (Gd₂O₂S:Tb), Caesium iodide doped with Thallium (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Also, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

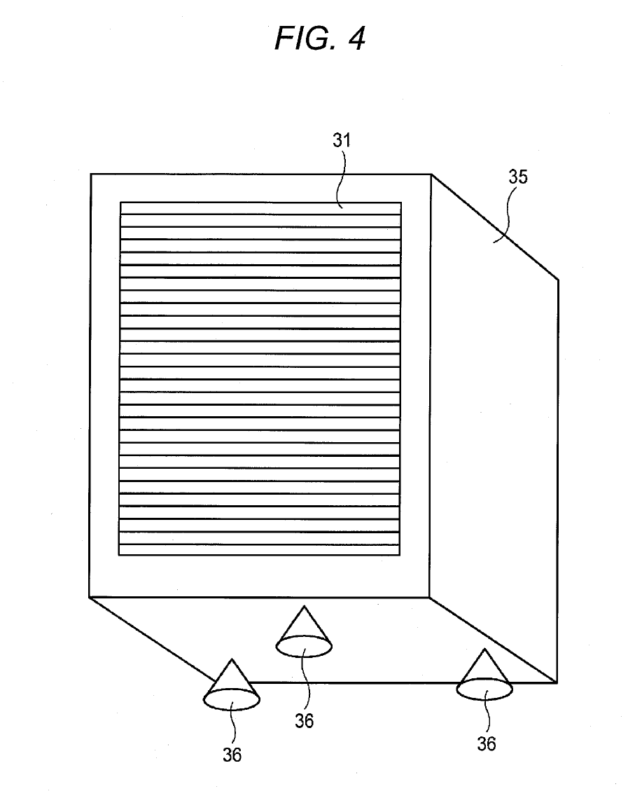

FIG. 4 is a perspective view showing buffer materials 36 that are provided to the grating unit housing 35.

The grating unit housing 35 is accommodated in the guide housing 16 (refer to FIG. 1) with conical buffer materials 36 being interposed between the grating unit housing and the guide housing. Specifically, the buffer materials 36 that buffer the force, vibration and the like transferred from the guide housing 16 are provided between the grating unit housing 35 at a lower side of a vertical direction, which is one direction of in-plane directions orthogonal to the optical axis A, and an inner wall of the guide housing 16. The grating unit housing 35 is supported to the guide housing 16 with upright standing up through the buffer materials 36. A buffering direction by the buffer materials 36 is mainly a vertical direction. When the guide housing 16 vibrates due to the weight of the subject supported at the guide housing 16, the buffer materials 36 block the transfer of the force and vibration from the guide housing 16 to the grating unit housing 35.

The buffer materials 36 are made of rubber, resin and the like and are provided to support three points of a periphery of a lower surface of the grating unit housing 35. The three points are three points whose one point is not provided on a same line, and one surface is defined by the three points. Accordingly, the grating unit housing 35 is three point-supported, so that it is little inclined with respect to the vertical direction. As a result, it is possible to stably support the grating unit housing 35. Also, on the lower surface of the grating unit housing 35, at least two sets of the buffer materials 36, each set consisting of two buffer materials 36 with the center of gravity being interposed therebetween, are arranged at the periphery that is positioned at an outer more side than the center of gravity. Hence, the stable support is possible. Also, the support positions of the buffer materials 36 are not limited to the three points. For example, three or more points whose one point is not provided on a same line are preferable.

In addition, the buffer materials 36 may be provided on an upper surface of the grating unit housing 35 or a side surface orthogonal to the optical axis A, in addition to the lower surface of the grating unit housing with respect to the vertical direction. At this time, compared to a configuration in which the buffer materials 36 are provided on both opposing surfaces such as upper and lower surfaces and left and right surfaces, a configuration in which the buffer materials 36 are provided on only one side is preferable because the more favorable buffer effect is obtained in many cases. When the buffer materials 36 are provided on a side surface, it is preferable that the buffer materials 36 are provided to a periphery of the corresponding side surface so as not to shield the X-ray. The more the surfaces on which the buffer materials 36 are provided, the more the number of support positions on each of the surfaces, i.e., the more the support contact areas between the grating unit housing 35 and the guide housing 16, the possibility that the grating unit housing 35 can be stably supported is increased. However, when the number of the support surfaces, the number of the support positions and the support contact areas are too much, it is difficult to shield the force or vibration transfer from the guide housing 16 to the grating unit housing 35. Accordingly, the number of the support surfaces, the number of the support positions and the support contact areas are determined by comparing the stable support with the shielding of the force and vibration transfer.

The number and shape of the buffer materials 36 are not limited to the configuration shown in FIG. 4. In FIG. 4, the grating unit housing 35 is supported at the three points through the three buffer materials 36. For example, one buffer material 36 may be provided which has three protrusions at positions corresponding to the three points. In addition, for example, one cylindrical buffer material may be provided at the center of gravity of the lower surface of the grating unit housing 35.

As described above, the imaging unit 12 having the first and second gratings 31, 32 and the FPD 30 is accommodated in the guide housing 16, so that it is possible to narrow a distance between the subject H and the imaging unit 12, compared to a configuration in which the first and second gratings 31, 32 and the FPD 30 are separately provided from the guide housing 16. Thereby, it is possible to make the radiographic system 10 compact and to enlarge an imaging region of the subject H.

In addition, the imaging unit 12 is accommodated in the guide housing 16, so that it is possible to prevent the external force from being directly applied to the first and second gratings. Furthermore, the grating unit housing 35 having the first and second gratings 31, 32 accommodated therein is supported to the guide housing 16 via the buffer materials 36. Thereby, even when the guide housing is vibrated due to the shock or weight in positioning the subject H, the relative position relation between the X-ray focus and the imaging unit 12 in the guide housing 16 is stably kept. That is, even when the force or vibration is applied to the guide housing 16, the deviation of the relative position between the X-ray focus and the imaging unit 12 is suppressed, so that it is possible to suppress the quality of the phase contrast image from being deteriorated and to capture the favorable phase contrast image.

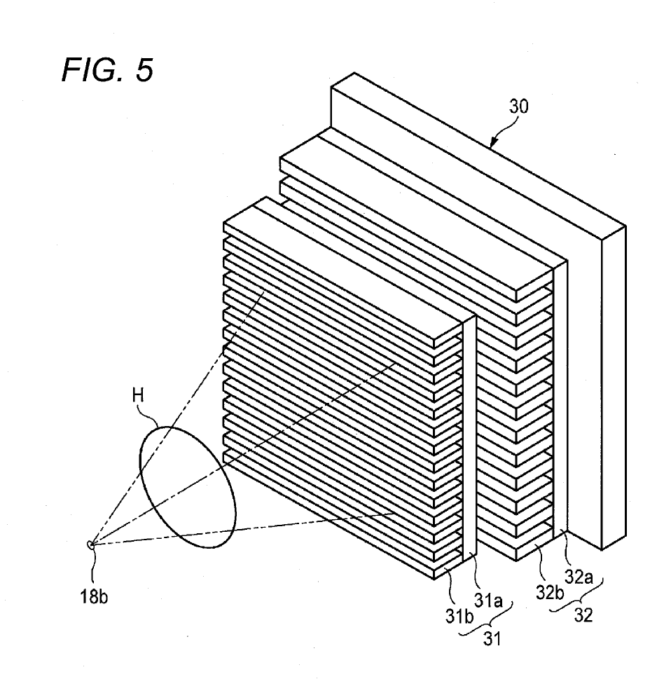

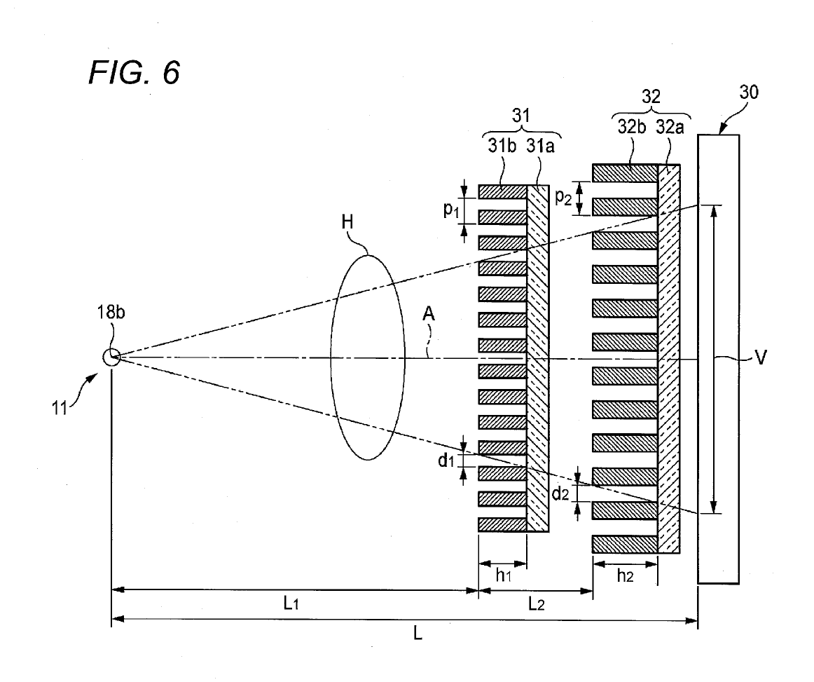

FIGS. 5 and 6 show the first and second gratings 31, 32 and the FPD 30.

The first absorption type grating 31 has a substrate 31a and a plurality of X-ray shield units 31b arranged on the substrate 31a. Likewise, the second absorption type grating 32 has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having high X-ray attenuation coefficient are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p1 and at a predetermined interval d1 in the direction (x direction) orthogonal to the one direction. Likewise, the X-ray shield units 32b are arranged on the in-plane orthogonal to the optical axis A of the X-ray with a constant pitch p2 and at a predetermined interval d2 in the direction (x direction) orthogonal to the one direction. The arrangement direction of the X-ray shield units 31b, 32b coincides with the scanning direction by the scanning mechanism 33 and the main buffering direction by the buffer materials 36. Since the first and second absorption type gratings 31, 32 provide the incident X-ray with an intensity difference, rather than the phase difference, they are also referred to as amplitude type gratings. Also, the slit (area of the interval d1 or d2) may not be a void. For example, the void may be filled with X-ray low absorption material such as polymer material or light metal.

The first and second absorption type gratings 31, 32 are adapted to geometrically image the X-ray having passed through the slits, regardless of the Talbot interference effect. Specifically, the intervals d1, d2 are set to be sufficiently larger than a peak wavelength of the X-ray irradiated from the X-ray source 11, so that most of the X-ray included in the irradiated X-ray is enabled to pass through the slits, without being diffracted in the slits. For example, when the rotary anode 18a is made of tungsten and the tube voltage is 50 kV, the peak wavelength of the X-ray is about 0.4 Å. In this case, when the intervals d1, d2 are set to be about 1 to 10 μm, most of the X-ray is geometrically projected in the slits while the X-ray is not diffracted therein.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p2 and the interval d2 of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L1 and a distance from the first absorption type grating 31 to the second absorption type grating 32 is L2, the grating pitch p2 and the interval d2 are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 )\end{matrix}$$

In the Talbot interferometer, the distance L2 from the first absorption type grating 31 to the second absorption type grating 32 is restrained with a Talbot interference distance that is determined by a grating pitch of a first diffraction grating and an X-ray wavelength. However, in the X-ray imaging system 10 of the invention, since the first absorption type grating 31 projects the incident X-ray without diffracting the same and the G1 image of the first absorption type grating 31 is similarly obtained at all positions of the rear of the first absorption type grating 31, it is possible to set the distance L2 irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p1 of the first absorption type grating 31, the grating pitch p2 of the second absorption type grating 32, the X-ray wavelength (typically, effective wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a cone beam and is known in “Atsushi Momose, et al., Japanese Journal of Applied Physics, Vol. 47, No. 10, 2008, August, page 8077).

In the X-ray imaging system (10), the distance L2 is set to be shorter than the minimum Talbot interference distance Z when m=1 so as to make the imaging unit 12 thin. That is, the distance L2 is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L2 is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a periodic pattern image having high contrast, it is preferable that the X-ray shield units 31b, 32b perfectly shield (absorb) the X-ray. Even when the materials (gold, platinum and the like) having high X-ray attenuation coefficient are used, no small part of X-rays penetrates the X-ray shield units. Accordingly, in order to improve the shield ability of X-ray, it is preferable to make thickness h1, h2 of the X-ray shield units 31b, 32b thicker as much as possible, respectively. For example, when the tube voltage applied to the X-ray tube 18 is 50 kV, it is preferable to shield 90% or more of the irradiated X-ray. In this case, the thickness h1, h2 are preferably 30 μm or larger, based on gold (Au).

In the meantime, when the thickness h1, h2 of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction of the X-ray shield units 31b, 32b is narrowed. Therefore, from a standpoint of securing the field of view, the upper limits of the thickness h1, h2 are defined. In order to secure a length V of the effective field of view in the x direction on the detection surface of the FPD 30, when a distance from the X-ray focus 18b to the detection surface of the FPD 30 is L, the thickness h1, h2 are necessarily set to satisfy following equations (7) and (8), from a geometrical relation shown in FIG. 6.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d1=2.5 μm, d2=3.0 μm and L=2 m, assuming a typical clinical use in a hospital, the thickness h1 should be 100 μm or smaller and the thickness h2 should be 120 μm or smaller so as to secure a length of 10 cm as the length V of the effective field of view in the x direction.

In the imaging unit 12 configured as described above, an intensity-modulated image is formed by the superimposition of the G1 image of the first absorption type grating 31 and the second absorption type grating 32 and is captured by the FPD 30. A pattern period p1′ of the G1 image at the position of the second absorption type grating 32 and a substantial grating pitch p2′ of the second absorption type grating 32 (substantial pitch after the manufacturing) are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p1′ of the G1 image and the grating pitch p2′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust the relation of the arrangement pitch P and the moiré period T, it is preferable to adjust the positions of the first and second absorption type gratings 31, 32 and to change at least one of the pattern period p1′ of the G1 image and the grating pitch p2′, thereby changing the moiré period T.

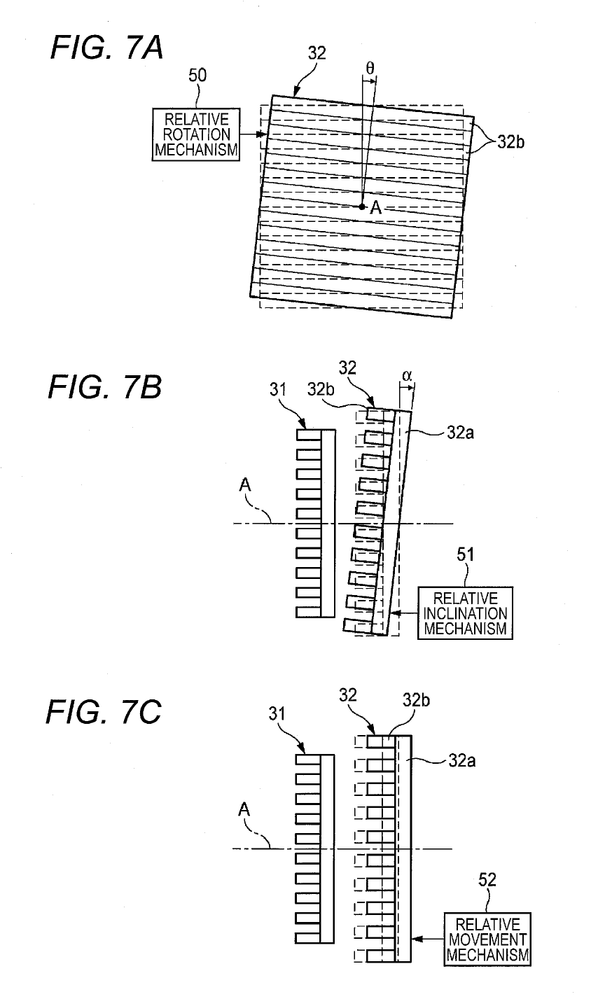

FIGS. 7A to 7C show a method of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p2′” to “p2′/cos θ”, so that the moiré period T is changed (refer to FIG. 7A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p2′” to “p2′×cos θ”, so that the moiré period T is changed (refer to FIG. 7B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L2 between the first absorption type grating 31 and the second absorption type grating 32. When the second absorption type grating 32 is moved along the optical axis A by a movement amount δ by the relative movement mechanism 52, the pattern period of the G1 image of the first absorption type grating 31 projected at the position of the second absorption type grating 32 is changed from “p1′” to “p1′×(L1+L2+δ)/(L1+L2)”, so that the moiré period T is changed (refer to FIG. 7C).

In the X-ray imaging system 10, since the imaging unit 12 is not the Talbot interferometer and can freely set the distance L2, it can appropriately adopt the mechanism for changing the distance L2 and to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the subject H is arranged between the X-ray source 11 and the first absorption type grating 31, the moiré fringe that is detected by the FPD 30 is modulated by the subject H. An amount of the modulation is proportional to the angle of the X-ray that is deviated by the refraction effect of the subject H. Accordingly, it is possible to generate the phase contrast image of the subject H by analyzing the moiré fringe detected by the FPD 30.

In the below, an analysis method of the moiré fringe is described.

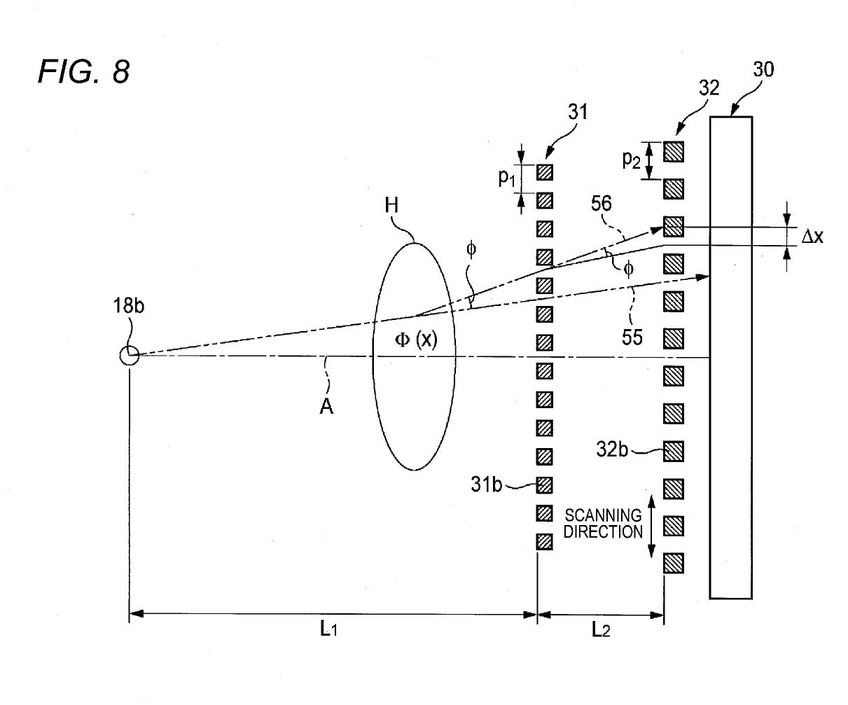

FIG. 8 shows one X-ray that is refracted in correspondence to a phase shift distribution Φ(x) in the x direction of the subject H.

A reference numeral 55 indicates a path of the X-ray that goes straight when there is no subject H. The X-ray traveling along the path 55 passes through the first and second absorption type gratings 31, 32 and is then incident onto the FPD 30. A reference numeral 56 indicates a path of the X-ray that is refracted and deviated by the subject H. The X-ray traveling along the path 56 passes through the first absorption type grating 31 and is then shielded by the second absorption type grating 32.

The phase shift distribution Φ(x) of the subject H is expressed by a following equation (12), when a refractive index distribution of the subject H is indicated by n(x, z) and the traveling direction of the X-ray is indicated by Z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) by using a wavelength λ of the X-ray and the phase shift distribution Φ(x) of the subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the subject H is related to the phase shift distribution Φ(x) of the subject H. Also, the amount of displacement Δx is related to a phase deviation amount ψ of a signal output from each pixel 40 of the FPD 40 (a phase deviation amount of a signal of each pixel 40 obtained when there is the subject H and when there is no subject H), as expressed by a following equation (15).

$$\begin{matrix}[ equation 15 ] & \\ \begin{matrix}ψ = \frac{2 π}{{p}_{2}} Δ x \\ = \frac{2 π}{{p}_{2}} {L}_{2} ϕ\end{matrix} & ( 15 )\end{matrix}$$

Therefore, when the phase deviation amount ψ of a signal of each pixel 40 is calculated, the refraction angle φ is obtained from the equation (15) and a differential of the phase shift distribution Φ(x) is obtained by using the equation (14). Hence, by integrating the differential of the phase shift distribution Φ(x) with respect to x, it is possible to generate the phase shift distribution Φ(x) of the subject H, i.e., the phase contrast image of the subject H. In the X-ray imaging system 10 of this illustrative embodiment, the phase deviation amount ψ is calculated by using a fringe scanning method that is described below.

In the fringe scanning method, an imaging is performed while one of the first and second absorption type gratings 31, 32 is stepwise translation-moved relatively to the other in the x direction, in other words, an imaging is performed while changing the phases between both gratings. In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance in the x direction reaches one period of the grating period of the second absorption type grating 32, the phase change between the two gratings reaches 2π, and the moiré fringe returns to its original position. Regarding the movement of the moiré fringe, while moving the second absorption type grating 32 by 1/n (n: integer) with respect to the grating pitch p2, the fringe images are captured in the FPD 30 and the signals of the respective pixels 40 are obtained from the captured fringe images and calculated in the calculation processing unit 22, so that the phase deviation amount ψ of the signal of each pixel 40 is obtained.

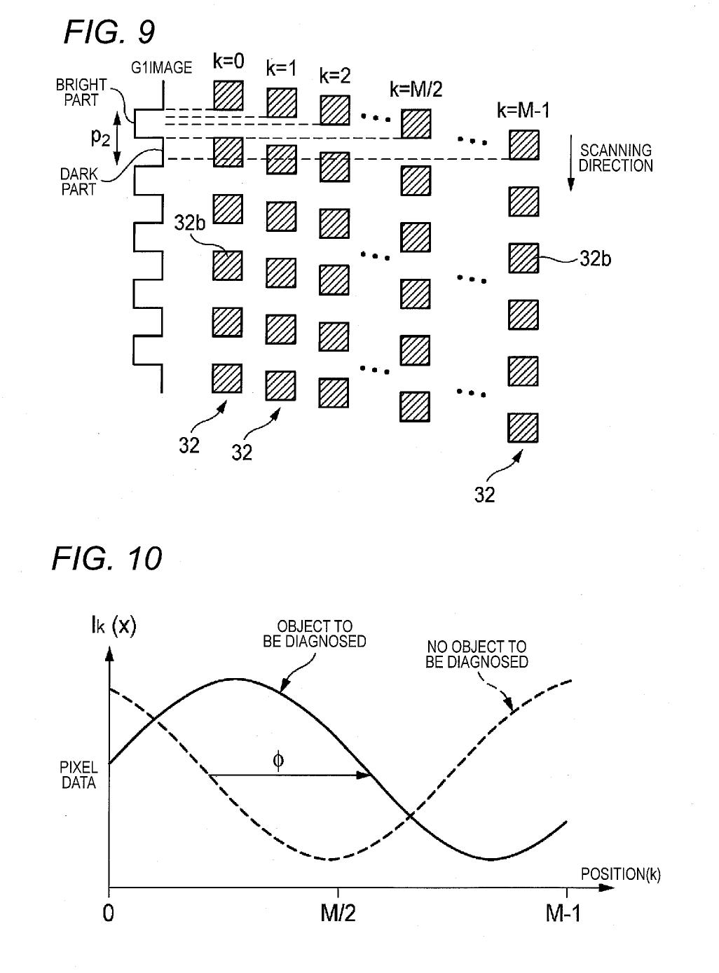

FIG. 9 pictorially shows that the second absorption type grating 32 is moved by a scanning pitch (p2/M) that is obtained by dividing the grating pitch p2 into M (M: integer of 2 or larger).

The scanning mechanism 33 sequentially translation-moves the second absorption type grating 32 at each of M scanning positions of k=0, 1, 2, . . . , M−1. In FIG. 9, an initial position of the second absorption type grating 32 is a position (k=0) at which a dark part of the G1 image at the position of the second absorption type grating 32 when there is no subject H substantially coincides with the X-ray shield unit 32b. However, the initial position may be any position of k=0, 1, 2, . . . , M−1.

First, at the position of k=0, mainly, the X-ray that is not refracted by the subject H passes through the second absorption type grating 32. Then, when the second absorption type grating 32 is moved in order of k=1, 2, . . . , regarding the X-ray passing through the second absorption type grating 32, the component of the X-ray that is not refracted by the subject H is decreased and the component of the X-ray that is refracted by the subject H is increased. In particular, at the position of k=M/2, mainly, only the X-ray that is refracted by the subject H passes through the second absorption type grating 32. At the position exceeding k=M/2, contrary to the above, regarding the X-ray passing through the second absorption type grating 32, the component of the X-ray that is refracted by the subject H is decreased and the component of the X-ray that is not refracted by the subject H is increased.

At each position of k=0, 1, 2, . . . , M−1, when the imaging is performed by the FPD 30, M signal values are obtained for the respective pixels 40. In the below, a method of calculating the phase deviation amount ψ of the signal of each pixel 40 from the M signal values is described. When a signal value of each pixel 40 at the position k of the second absorption type grating 32 is indicated with Ik(x), Ik(x) is expressed by a following equation (16).

$$\begin{matrix}[ equation 16 ] & \\ {I}_{k} ( x ) = {A}_{0} + {\sum }_{n > 0}^{ } {A}_{n} exp [ 2 π i \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A0 is the intensity of the incident X-ray and An is a value corresponding to the contrast of the signal value of the pixel 40 (n is a positive integer). Also, φ(x) indicates the refraction angle φ as a function of the coordinate x of the pixel 40.

When a following equation (17) is used, the refraction angle φ(x) is expressed by a following equation (18).

$$\begin{matrix}[ equation 17 ] & \\ {\sum }_{k = 0}^{M - 1} exp ( - 2 π \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg[ ] means the extraction of the argument and corresponds to the phase deviation amount φ of the signal of each pixel 40. Therefore, from the M signal values obtained from the respective pixels 40, the phase deviation amount φ of the signal of each pixel 40 is calculated based on the equation (18), so that the refraction angle φ(x) is acquired.

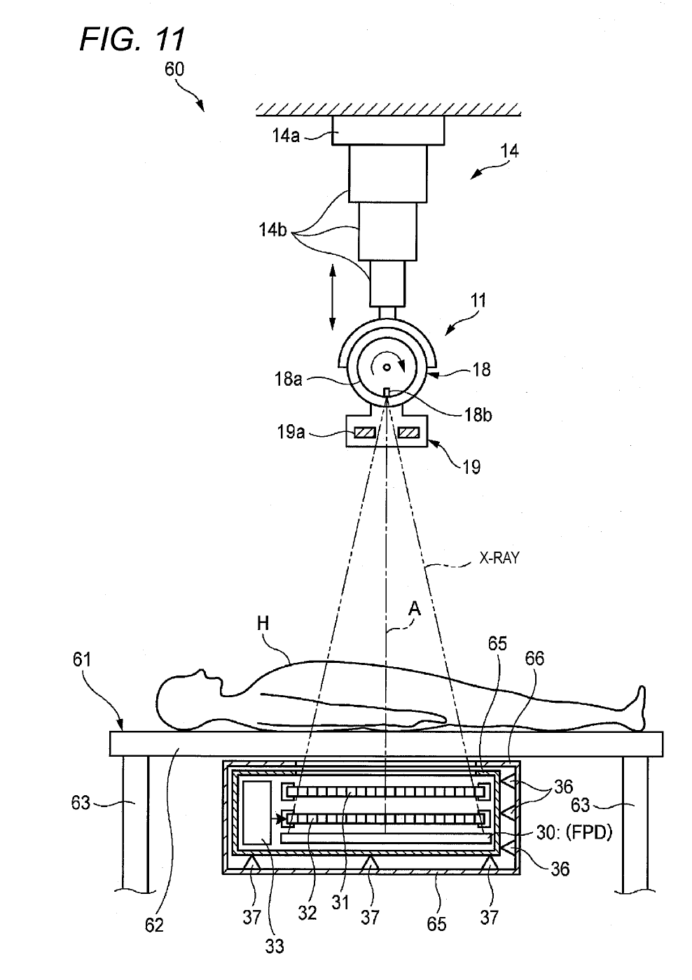

FIG. 10 shows a signal of one pixel of the radiological image detector, which is changed with the fringe scanning.

The M signal values obtained from the respective pixels 40 are periodically changed with the period of the grating pitch p2 with respect to the position k of the second absorption type grating 32. The dotted line of FIG. 10 indicates the change of the signal value when there is no subject H and the solid line of FIG. 10 indicates the change of the signal value when there is the subject H. A phase difference of both waveforms corresponds to the phase deviation amount φ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis.

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the subject H is finally displayed on the monitor 24.

Also, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical practice, as the X-ray source 11. In the meantime, since it is possible to arbitrarily set the distance L2 from the first absorption type grating 31 to the second absorption type grating 32 and to set the distance L2 to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is improved, it is possible to improve the detection sensitivity of the phase contrast image.

Also, in the X-ray imaging system 10, the refraction angle φ is calculated by performing the fringe scanning for the projection image of the first grating. Thus, it has been described that the first and second gratings are the absorption type gratings. However, the invention is not limited thereto. As described above, the invention is useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe such as method of using Fourier transform/inverse Fourier transform known in “J. Opt. Soc. Am. Vol. 72, No. 1 (1982) p. 156” may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the subject. Accordingly, the image based on the refraction angle φ and the image based on the differential of the phase shift distribution Φ are also included in the phase contrast image.

In the X-ray phase imaging of using the first and second absorption gratings 31, 32, from a standpoint of the phase detection accuracy, the relative position of the first and second gratings 31, 32 and the respective relative positions of the X-ray focus 18a and the first and second gratings 31, 32 are particularly important. As described above, the imaging unit 12 is accommodated in the guide housing 16 and the grating unit housing 35 including the first and second gratings 31, 32 are supported to the lower surface of the guide housing 16 via the buffer materials 36, so that it is possible to block the force and vibration from being transferred to the grating unit housing 35 from the guide housing 16 and to prevent the external force from being directly applied to the first and second gratings 31, 32. Thereby, it is possible to suppress the first and second gratings from being inclined from the respective set grating surfaces due to the vibration and the like and to thus suppress the relative positions of the first and second gratings from being deviated. Also, it is possible to suppress the deviation of the respective relative positions of the focus 18a and the first and second gratings. As a result, it is possible to suppress the quality of the phase contrast image from being deteriorated and to capture the appropriate phase contrast image. In addition, regarding the force and vibration to be applied to the guide housing 16, the vibration that is transferred from the bottom on which the X-ray imaging system 10 is mounted, the vibration that is transferred from the X-ray source 11 depending on the apparatus mount circumstances and the like may be also considered, in addition to the shock caused in positioning the subject H and the motion of the subject.

In particular, the buffer materials 36 are provided on the lower surface of the grating unit housing 35, which is the opposing surface of the grating unit housing 35 to the inner wall of the guide housing 16, in the second direction (x direction) that is the arrangement direction of the X-ray shield units 31b, 32b and the scanning direction of the scanning mechanism 33. Therefore, when performing the scanning imaging by moving the second grating 32 relatively to the first grating 31 in the x direction, it is to possible to prevent the external force or external vibration from being transferred from the guide housing 16 to the first and second gratings 31, 32 and thus the first and second gratings 31, 32 from being relatively moved in the same x direction. That is, when performing the scanning imaging, the relative positions of the first and second gratings 31, 32 to the X-ray focus 18a are suppressed from being deviated in the arrangement direction of the X-ray shield units 31b, 32b, so that the radiological image of the first grating is suppressed from being blurred in the x direction at the incident position onto the second grating. As a result, it is possible to suppress the contrast of the signal value of the pixel 40 in the FPD 30 and the quality of the phase contrast image from being lowered and to capture the appropriate phase contrast image.

Furthermore, the lower surface of the grating unit housing 35 in the vertical direction is supported at the three or more points, so that it is possible to prevent the inclination of the grating unit housing 35 and to stabilize the same. Thereby, it is possible to suppress the relative positions of the first and second gratings 31, 32 to the X-ray focus 18a from being deviated more securely.

In the above illustrative embodiment, the first and second gratings 31, 32 are accommodated in the grating unit housing 35. However, the invention is not limited thereto. For example, the first and second gratings 31, 32 may be respectively supported on the inner wall of the guide housing 16 via the buffer materials.

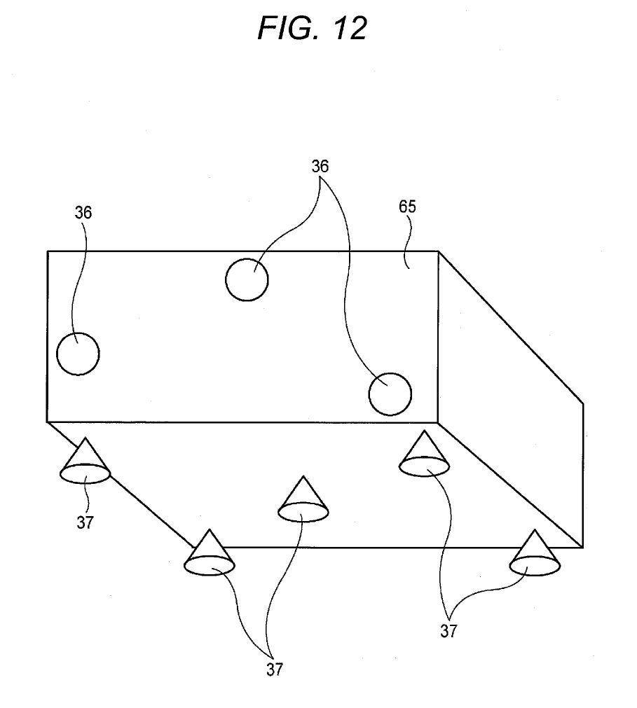

FIG. 11 shows another example of a configuration of a radiographic system for illustrating an illustrative embodiment of the invention.

An X-ray imaging system 60 is an apparatus that performs an imaging while the subject H (patient) lies down, and includes the X-ray source 11, the imaging unit 12 and a bed 61 on which the subject H lies down. The bed 61 has a top plate 62 to which the subject H is contacted and a guide housing 66 that supports the subject H via the top plate 61. The configurations of the X-ray source 11, the first and second gratings 31, 32 of the imaging unit 10, the FPD 30 and the scanning mechanism 33 are the same as the above configurations and the same reference numerals are thus used. Hereinafter, the same configurations as the above are indicated with the same reference numerals and the descriptions thereof are omitted. The differences from the above are described. Since the other configurations and the effects are the same as the above, the descriptions thereof are also omitted.

In this illustrative embodiment, the imaging unit 12 is attached on a lower surface of the top plate 62 so as to face the X-ray source 11 through the subject H. The X-ray source 11 is held by the X-ray source holding device 14 and the X-ray irradiation direction faces downwards by an angle changing device (not shown) of the X-ray source 11. At this state, the X-ray source 11 irradiates the X-ray toward the subject H that lies down on the top plate 62 of the bed 61. Since the X-ray source holding device 14 can vertically move the X-ray source 11 by the expansion and contraction of the struts 14b, it is possible to adjust a distance from the X-ray focus 18a to the detection surface of the FPD 30 by the vertical movement.

As described above, since it is possible to shorten the distance L2 between the first absorption type grating 31 and the second absorption type grating 32 and to thus miniaturize the imaging unit 12, it is possible to shorten legs 63 supporting the top plate 62 of the bed 61 and to thus lower the position of the top plate 62. For example, it is preferable to miniaturize the imaging unit 12 and to lower the position of the top plate 62 to a height (for instance, about 40 cm from the bottom) at which the subject H (patient) can easily sit. Also, the lowering of the position of the top plate 62 is preferable when securing the sufficient distance from the X-ray source 11 to the imaging unit 12.

In addition, contrary to the position relation between the X-ray source 11 and the imaging unit 12, it may be possible to perform the imaging while the subject H lies down, by attaching the X-ray source 11 to the bed 61 and mounting the imaging unit 12 on the ceiling.

In the configuration shown in FIG. 11, the X-ray source 11 is provided above the bed 61, so that the first and second gratings 31, 32 and the FPD 30 are horizontally arranged with the respective X-ray incident surfaces thereof facing upwards. The first and second gratings 31, 32 and the FPD 30 are accommodated in the grating unit housing 65. Alternatively, only the first and second gratings 31, 32 except for the FPD 30 may be accommodated in the grating unit housing 65. At the state in which the relative positions of the first and second gratings 31, 32 and the FPD 30 are defined, the first and second gratings 31, 32 and the FPD 30 are overlapped and assembled in the direction of the optical axis A, so that they are fixed in the grating unit housing 65.

FIG. 12 is a perspective view showing a state in which the buffer materials are provided to the grating unit housing 65. In this illustrative embodiment, five buffer materials 37 are provided on a lower surface of the grating unit housing 65, which surface intersects with the vertical direction following the optical axis A, and the three buffer materials 36 are also provided on a side surface of the grating unit housing 65, which intersects with the scanning direction (x direction that is a pattern arrangement direction of the radiological image formed by the first grating 31) that is the in-plane one direction orthogonal to the optical axis A.

Like the buffer materials 36 of the above illustrative embodiment, the buffer materials 36 are provided between the grating unit housing and the inner wall of the guide housing 16 in the scanning direction (x direction) that is the in-plane one direction orthogonal to the optical axis A. Therefore, like the above illustrative embodiment, the radiological image of the first grating is suppressed from being blurred in the x direction at the incident position onto the second grating. As a result, it is possible to suppress the contrast of the intensity change detected in the FPD 30 and the quality of the phase contrast image from being lowered and to capture the appropriate phase contrast image.

The buffer materials 37 are provided at five positions of four corners and a central part of the lower surface of the grating unit housing 65. By the buffer materials 37, the respective relative positions of the focus 18a and the first and second gratings 31, 32 in the z direction following the optical axis A are suppressed from being deviated and the fluctuation of the spatial frequency of the moiré occurring in correspondence to the relative deviation amounts of the X-ray focus and the respective gratings is suppressed. Accordingly, it is possible to suppress the quality of the phase contrast image from being lowered and to capture the appropriate phase contrast image.

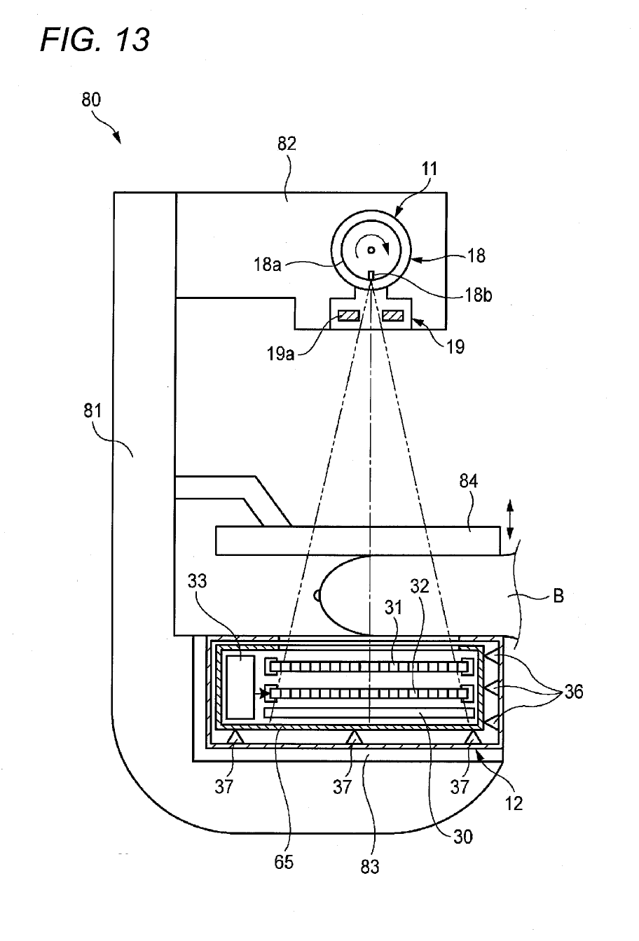

In the below, an illustrative embodiment is described in which the invention is applied to a mammography (X-ray breast imaging). A mammography apparatus 80 shown in FIG. 13 is an apparatus of capturing an X-ray image (phase contrast image) of a breast B that is the subject. The mammography apparatus 80 includes an X-ray source accommodation unit 82 that is mounted to one end of an arm member 81 rotatably connected to a base platform (not shown), an imaging platform 83 that serves as the guide housing and is mounted to the other end of the arm member 81 and a compressing plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The pressing plate 84 is moved by a moving mechanism (not shown) and presses the breast B between the compressing plate and the imaging platform 83. At this compressing state, the X-ray imaging is performed.

The grating unit housing 35 shown in FIG. 13 is supported to the imaging platform 83 via the buffer materials 36, 37, like the configuration shown in FIG. 11. Thereby, the same effects as the above are obtained.

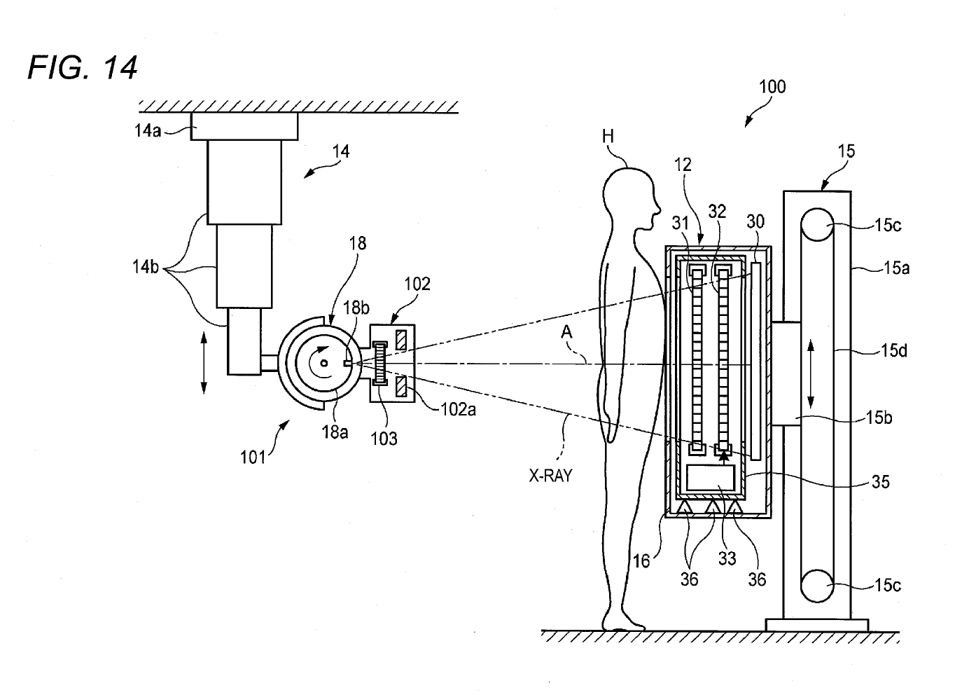

FIG. 14 shows another example of the radiographic system for illustrating an illustrative embodiment of the invention. A radiographic system 100 is different from the radiographic system 10 in that a multi-slit 103 is provided to a collimator unit 102 of an X-ray source 101.

In the above illustrative embodiment, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation from the X-ray source 11, thereby reducing the effective focus size in the x direction and forming a plurality of light sources with narrow focus (disperse light sources) in the x direction.

It is necessary to set a grating pitch p3 of the multi-slit 103 so that it satisfies a following equation (19), when a distance from the multi-slit 103 to the first absorption type grating 31 is L3.

$$\begin{matrix}[ equation 19 ] & \\ {p}_{3} = \frac{{L}_{3}}{{L}_{2}} {p}_{2} & ( 19 )\end{matrix}$$

Also, in this illustrative embodiment, since the position of the multi-slit 103 is substantially the X-ray focus position, the grating pitch p2 and the interval d2 of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Also, in this illustrative embodiment, when it is intended to secure a length V of the effective field of view in the x direction on the detection surface of the FPD 30, the thickness h1, h2 of the X-ray shield units 31b, 32b of the first and second absorption type gratings 31, 32 are determined to satisfy following equations (22) and (23) when a distance from the multi-slit 103 to the detection surface of the FPD 30 is L′.

$$\begin{matrix}[ equation 22 ] & \\ {h}_{1} \leq \frac{{L}^{′}}{V / 2} {d}_{1} & ( 22 ) \\ [ equation 23 ] & \\ {h}_{2} \leq \frac{{L}^{′}}{V / 2} {d}_{2} & ( 23 )\end{matrix}$$

The equation (19) is a geometrical condition so that the projection image (G1 image) of the X-ray, which is emitted from the respective light sources with narrow focus dispersedly formed by the multi-slit 103, by the first absorption type grating 31 coincides (overlaps) at the position of the second absorption type grating 32. Like this, in this illustrative embodiment, the G1 image based on the light sources with narrow focus formed by the multi-slit 103 overlaps, so that it is possible to improve the quality of the phase contrast image without lowering the X-ray intensity.

Also, the multi-slit 103 can be applied to any of the above illustrative embodiments.

In addition, in the above illustrative embodiments, as described above, the phase contrast image is based on the refracted components of the X-ray in the periodic arrangement direction (x direction) of the X-ray shield units 31b, 32b of the first and second absorption type gratings 31, 32, and the refracted components in the extending direction (y direction) of the X-ray shield units 31b, 32b are not reflected thereto. In other words, a part outline along the direction (when running at right angle, y direction) intersecting with the x direction is represented, as the phase contrast image based on the refracted components of the x direction, through the grating surface that is the xy plane, and a part outline following the x direction without intersecting with the x direction is not represented as the phase contrast image of the x direction. That is, there is a part that cannot be represented depending on the shape and direction of the part to be the subject H. For example, when a direction of a load surface of the articular cartilage of a knee is made to match the y direction of the xy directions that are the in-plane directions, a part outline adjacent to the load surface (yz plane) following the y direction is sufficiently represented but the tissue (for example, tendon, ligament and the like) around the cartilage, which intersects with the load surface and extends along the x direction, is not sufficiently represented. By moving the subject H, it is possible to capture the insufficiently represented part again. However, the burdens of the subject H and the operator are increased and it is difficult to secure the position reproducibility with the re-captured image.

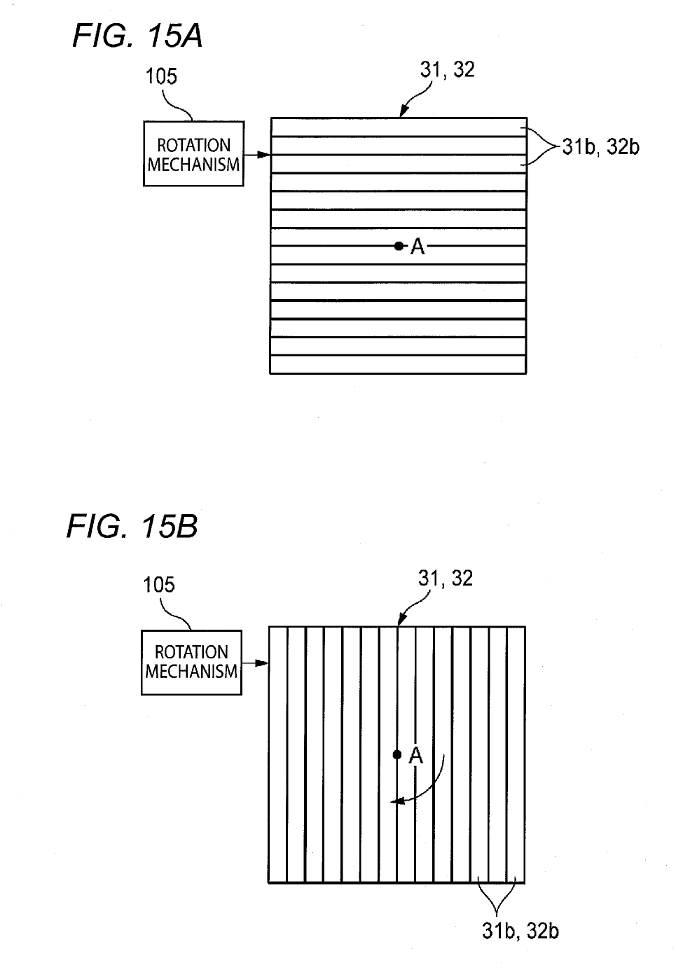

Accordingly, as another example, as shown in FIGS. 15A and 15B, it may be possible that a rotation mechanism 105, which integrally rotates the first and second absorption type gratings 31, 32 by an arbitrary angle from a first direction as shown in FIG. 15A to a second direction as shown in FIG. 15B about an imaginary line (the optical axis A of the X-ray) orthogonal to centers of the grating surfaces of the first and second absorption type gratings 31, 32, is provided and the phase contrast images are respectively generated at each of the first and second directions. By doing so, it is possible to solve the above problem of the position reproducibility. Also, in FIG. 15A, the first direction of the first and second gratings 31, 32 is shown in which the extending direction of the X-ray shield units 31b, 32b follows the y direction, and in FIG. 15B, the second direction of the first and second gratings 31, 32 is shown in which the state of FIG. 15A is rotated by 90 degrees and thus the extending direction of the X-ray shield units 31b, 32b follows the x direction. At this time, the rotating angle of the first and second gratings is arbitrary. In addition to the first and second directions, two or more rotation operations such as third and fourth directions may be performed and the phase contrast images may be generated at the respective directions.

Also, the rotation mechanism 105 may integrally rotate only the first and second absorption type gratings 31, 32 separately from the FPD 30 or integrally rotate the FPD 30 together with the first and second absorption type gratings 31, 32. Furthermore, the generation of the phase contrast images at the first and second directions by using the rotation mechanism 105 can be applied to any of the above illustrative embodiments. Here, when the multi-slit is provided, the multi-slit is configured to rotate in the same direction as the first and second gratings 31, 32.

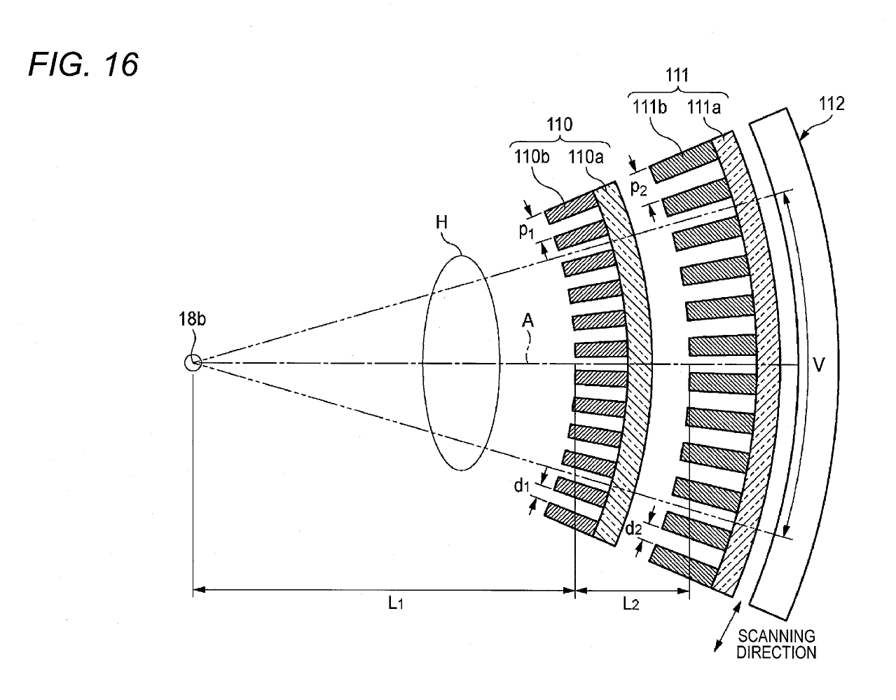

Also, the first and second absorption type gratings 31, 32 are configured so that the periodic arrangement direction of the X-ray shield units 31b, 32b is linear (i.e., the grating surfaces are planar). However, instead of this, first and second absorption type gratings 110, 111 having grating surfaces that are concave on a curved surface may be used, as shown in FIG. 16.

The first absorption type grating 110 has a plurality of X-ray shield units 110b, which are periodically arranged with a predetermined pitch p1 on a surface of a radiolucent and curved substrate 110a. Each of the X-ray shield units 110b linearly extends in the y direction, like the above illustrative embodiments, and a grating surface of the first absorption type grating 110 has a cylindrical shape having a central axis that is a line passing to the X-ray focus 18b and extending in the extending direction of the X-ray shield units 110b. Likewise, the second absorption type grating 111 has a plurality of X-ray shield units 111b, which are periodically arranged with a predetermined pitch p2 on a surface of a radiolucent and curved substrate 111a. Each of the X-ray shield units 111b linearly extends in the y direction, and a grating surface of the second absorption type grating 111 has a cylindrical shape having a central axis that is a line passing to the X-ray focus 18b and extending in the extending direction of the X-ray shield units 111b.

When a distance from the X-ray focus 18b to the first absorption type grating 110 is L1 and a distance from the first absorption type grating 110 to the second absorption type grating 111 is L2, the grating pitch p2 and the interval d2 are determined to satisfy the equation (1). The opening width d1 of the slit of the first absorption type grating 110 and the opening width d2 of the slit of the second absorption type grating 111 are determined to satisfy the equation (2).

Like this, the grating surfaces of the first and second absorption type gratings 110, 111 are made to be the cylindrical surfaces, so that the X-ray irradiated from the X-ray focus 18b is perpendicularly incident onto the grating surfaces when there is no subject H. Therefore, in this illustrative embodiment, the restraint on the upper limits of the thickness h1 of the X-ray shield unit 110b and the thickness h2 of the X-ray shield unit 111b is relaxed, so that it is not necessary to consider the equations (7) and (8).

Also, in this illustrative embodiment, one of the first and second absorption type gratings 110, 111 is moved in a direction following the grating surface (cylindrical surface) about the X-ray focus 18b, so that the above fringe scanning is performed. Furthermore, in this illustrative embodiment, it is preferable to use an FPD 112 having a detection surface that is a cylindrical surface. Likewise, the detection surface of the FPD 112 is a cylindrical surface having a central axis that is a line passing to the X-ray focus 18b and extending in the y direction.

The first and second absorption type gratings 110, 111 and the FPD 112 of this illustrative embodiment can be applied to any of the above illustrative embodiments. Further, it may be possible that the multi-slit 103 (refer to FIG. 14) has the same shape as the first and second absorption type gratings 110, 111.

Also, in each of the above illustrative embodiments, the second absorption type grating is provided separately from the FPD. However, the FPD of each illustrative embodiment may have a grating pattern by using the X-ray image detector that is disclosed in JP 2009-133823A, without using the second absorption type grating as the grating pattern.

The X-ray image detector is a direct conversion type that includes a conversion layer, which converts the X-ray into charges, and a charge collection electrode, which collects the charges converted by the conversion layer, for each pixel. The charge collection electrode has a plurality of linear electrode groups each of which consists of a plurality of linear electrodes, which are arranged with a pitch substantially coinciding with the fringe pattern period of the radiological image formed by the first grating 31 and are electrically connected to each other. The linear electrode groups are arranged with the positions thereof being deviated with a pitch shorter than a pitch of the linear electrodes so that the phases thereof are different from each other. Here, the grating pattern is configured by each of the linear electrode groups.

The X-ray image detector is configured as described above, so that the second absorption type grating is not required. As a result, it is possible to reduce the costs and to make the imaging unit further smaller. Also, since it is possible to acquire the fringe images having a plurality of phase components by one imaging, the physical scanning for the fringe scanning is not required.

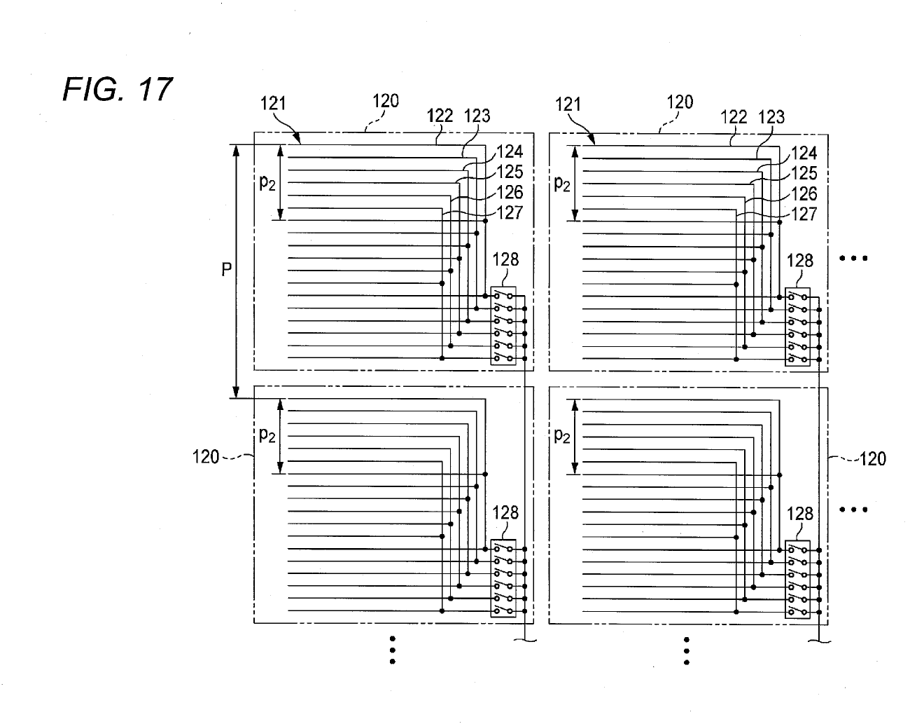

FIG. 17 shows a configuration of the X-ray image detector (FPD) of this illustrative embodiment. Pixels 120 are two-dimensionally arranged with a constant pitch in the x and y directions. Each pixel 120 is formed with a charge collection electrode 121 for collecting charges converted by a conversion layer that converts the X-ray into charges. The charge collection electrode 121 has first to sixth linear electrode groups 122 to 127. The respective linear electrode groups are offset by π/3 with respect to a phase of an arrangement period of the linear electrodes. Specifically, when a phase of the first linear electrode group 122 is 0, a phase of the second linear electrode group 123 is π/3, a phase of the third linear electrode group 124 is 2π/3, a phase of the fourth linear electrode group 125 is π, a phase of the fifth linear electrode group 126 is 4π/3 and a phase of the sixth linear electrode group 127 is 5π/3.

In each of the first to sixth linear electrode groups 122 to 127, the linear electrodes extending in the y direction are periodically arranged with a predetermined pitch p2 in the x direction. A relation of a substantial pitch p2′ (a substantial pitch after the manufacturing) of the arrangement pitch p2 of the linear electrodes, a pattern period p1′ of the G1 image at a position (a position of the X-ray image detector) of the charge collection electrode 121 and an arrangement pitch P of the pixels 120 in the x direction is necessary to satisfy the equation (10), based on the period T of the moiré fringe expressed by the equation (9) and to satisfy the equation (11), like the above illustrative embodiments.

Furthermore, each of the pixels 120 is provided with a switch group 128 for reading out the charges collected by the charge collection electrode 121. The switch group 128 consists of TFT switches each of which is provided to the first to sixth linear electrode groups 121 to 126, respectively. The charges collected by the first to sixth linear electrode groups 121 to 126 are individually read out under control of the switch groups 128, so that it is possible to acquire six fringe images having different phases by one imaging and to generate the phase contrast image based on the six fringe images.

By using the X-ray image detector having the above configuration, the second absorption type grating is not necessary for the imaging unit. As a result, it is possible to reduce the costs and to make the imaging unit further smaller. Also, in this illustrative embodiment, since it is possible to acquire the fringe images having a plurality of phase components by one imaging, the physical scanning for the fringe scanning is not required, so that the scanning mechanism can be excluded. In addition, regarding the configuration of the charge collection electrodes, the other configuration as disclosed in JP-A-2009-133823 may be used instead of the above configuration.

The above illustrative embodiments relate to the application in which the invention is applied to the medical diagnosis apparatus. However, the invention is not limited to the medical diagnosis apparatus and can be applied to the other radiation detection apparatus for industrial use.

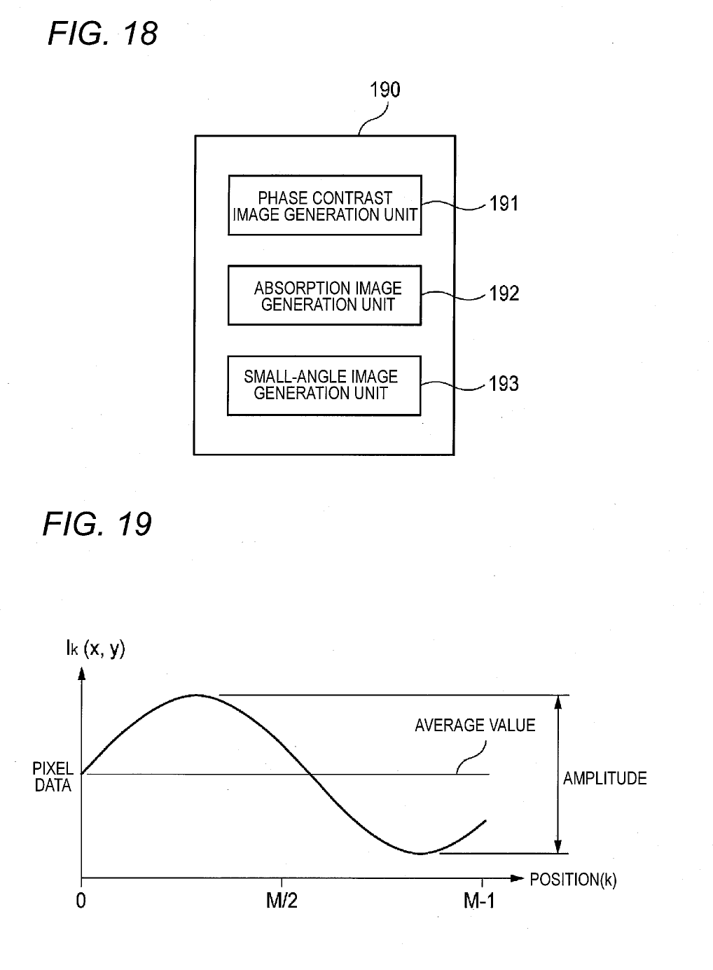

FIG. 18 shows another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent a tissue characterization caused due to the fine structure in the subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Ik(x, y), which is obtained for each pixel, with respect to k, as shown in FIG. 19, and thus calculates an average value and images the image data, thereby generating an absorption image. Also, the calculation of the average value may be performed by averaging the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

The small-angle scattering image generation unit 193 calculates an amplitude value of the image data Ik(x, y), which is obtained for each pixel, and thus images the image data, thereby generating a small-angle scattering image. Also, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

According to the X-ray imaging system of this illustrative embodiment, the absorption image or small-angle scattering image is generated from the plurality of images acquired for the phase contrast image of the subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the subject, compared to a configuration in which the imaging is separately performed so as to acquire the absorption image and the small-angle scattering image.

As described above, the specification discloses a radiographic apparatus that includes: a guide housing supporting a subject to which radiation is irradiated, a first grating, a grating pattern having a period and masking a radiological image formed by the radiation having passed through the first grating, and a radiological image detector that detects the radiological image masked by the grating pattern, wherein the first grating, the grating pattern and the radiological image detector are accommodated in the guide housing, and wherein at least the first grating and the grating pattern of the first grating, the grating pattern and the radiological image detector are supported to the guide housing with a buffer material being interposed between the first grating and grating pattern and an inner wall of the guide housing.

Also, according to the radiographic apparatus disclosed in the specification, the buffer material is provided between the first grating and grating pattern on at least a lower side of a vertical direction and the inner wall of the guide housing.

Also, according to the radiographic apparatus disclosed in the specification, the buffer material is provided between the first grating and grating pattern and the inner wall of the guide housing in a direction following the optical axis.

Also, according to the radiographic apparatus disclosed in the specification, the buffer material is provided between the first grating and grating pattern and the inner wall of the guide housing in at least one direction of in-plane directions orthogonal to the optical axis.

Also, according to the radiographic apparatus disclosed in the specification, the buffer material is provided between the first grating and grating pattern and the inner wall of the guide housing in a pattern arrangement direction of the grating pattern.

Also, according to the radiographic apparatus disclosed in the specification, at least the first grating and the grating pattern of the first grating, the grating pattern and the radiological image detector overlap with each other in a direction of the first grating and the grating pattern following an optical axis of the radiation, thereby configuring a unit, and the buffer material supports three or more points, whose at least one point does not exist on a same line, on an opposing surface of the unit to the inner wall of the guide housing.

Also, according to the radiographic apparatus disclosed in the specification, the buffer material supports the three points whose one point does not exist on a same line.

Also, according to the radiographic apparatus disclosed in the specification, at least the first grating and the grating pattern of the first grating, the grating pattern and the radiological image detector overlap with each other in a direction of the first grating and the grating pattern following an optical axis of the radiation, thereby configuring a unit, and the buffer material supports at least a part of a periphery of an opposing surface of the unit to the inner wall of the guide housing.

Also, according to the radiographic apparatus disclosed in the specification, the grating pattern is a second grating, and a scanning mechanism that relatively moves one of the first grating and the second grating in the second direction is further provided.

Also, according to the radiographic apparatus disclosed in the specification, the first grating has a plurality of radiation shield units that extends in a first direction and is arranged with a first pitch in a second direction orthogonal to the first direction, the second grating has a plurality of radiation shield units that extend in the first direction and is arranged with a second pitch in the second direction, the second pitching being the substantially same as a period pattern of the radiological image formed by the first grating, and when a distance from a focus of the radiation source to the first grating is L1, a distance from the first grating to the second grating is L2, the first pitch is p1 and the second pitch is p2, a following equation is satisfied.

p2={(L1+L2)/L1}×p1.

Also, according to the radiographic apparatus disclosed in the specification, when intervals in the second direction between the radiation shield units neighboring to each other of the respective first and second gratings are respectively d1 and d2, a following equation is satisfied.

d2={(L1+L2)/L1}×d1.

Also, according to the radiographic apparatus disclosed in the specification, the radiological image detector includes a conversion layer that converts the radiation into charges and a charge collection electrode that collects the charges converted by the conversion layer, for each pixel, the charge collection electrode has a plurality of linear electrode groups each of which consists of a plurality of linear electrodes, which are arranged with a pitch and masks the radiological image and are electrically connected to each other, the linear electrode groups are arranged so that phases thereof are different from each other, and the grating pattern is configured by each of the linear electrode groups.

Also, according to the radiographic apparatus disclosed in the specification, a radiation source for irradiating the radiation toward the first grating is further provided.

Also, the specification discloses a radiographic system including a calculation processing unit that calculates, from an image detected by the radiological image detector of the radiographic apparatus, a distribution of refraction angles of the radiation incident onto the radiological image detector and generates a phase contrast image of a subject based on the distribution of the refraction angles.

What is claimed is:

1. A radiographic apparatus comprising:
a guide housing that houses a first grating unit, the grating pattern unit, and a radiological image detector and supports a subject to which radiation is irradiated;
the first grating unit;
the grating pattern unit that includes a periodic form having a period and masks a radiological image formed by the radiation having passed through the first grating; and
the radiological image detector that detects a masked radiological image which is formed by masking the radiological image by the grating pattern unit,
wherein the first grating unit and the grating pattern unit are supported by the guide housing with a buffer material being interposed between the first grating unit and the grating pattern unit and an inner wall of the guide housing.

2. The radiographic apparatus according to claims 1, wherein the buffer material is provided between a lower side of the first grating unit or the grating pattern unit in a vertical direction and the inner wall of the guide housing.

3. The radiographic apparatus according to claim 1, wherein the buffer material is provided between the first grating unit or the grating pattern unit and the inner wall of the guide housing in a direction along which the first grating unit and the grating pattern unit are arranged.

4. The radiographic apparatus according to claim 1, wherein the buffer material is provided between the first grating unit and the grating pattern unit and the inner wall of the guide housing in a direction orthogonal to a direction along which the first grating unit and the grating pattern unit are arranged.

5. The radiographic apparatus according to claim 4, wherein the buffer material is provided between the first grating unit and the grating pattern unit and the inner wall of the guide housing in a pattern arrangement direction of the grating pattern unit.

6. The radiographic apparatus according to claim 1, wherein the first grating unit and the grating pattern unit overlap with each other in a direction along an optical axis of the radiation to form a unit, and
wherein the buffer material supports three or more points, whose at least one point does not exist on a same line, on an opposing surface of the unit to the inner wall of the guide housing.

7. The radiographic apparatus according to claim 6, wherein the buffer material supports the three points whose one point does not exist on a same line.

8. The radiographic apparatus according to claim 1, wherein the first grating unit and the grating pattern unit overlap with each other in a direction along an optical axis of the radiation to form a unit and
wherein the buffer material supports at least a part of a periphery of an opposing surface of the unit to the inner wall of the guide housing.

9. The radiographic apparatus according to claim 1, wherein the grating pattern unit is a second grating unit, and
further comprising a scanning mechanism that relatively moves one of the first grating unit and the second grating unit in the second direction.

10. The radiographic apparatus according to claim 9, wherein the first grating unit has a plurality of radiation shield units that extends in a first direction and is arranged with a first pitch in a second direction orthogonal to the first direction,
wherein the second grating unit has a plurality of radiation shield units that extend in the first direction and is arranged with a second pitch in the second direction, the second pitching being the substantially same as a period pattern of the radiological image formed by the first grating unit, and
wherein when a distance from a focus of a radiation source to the first grating unit is L1, a distance from the first grating unit to the second grating unit is L2, the first pitch is p1 and the second pitch is p2, a following equation is satisfied.
p2={(L1+L2)/L1}×p1.

11. The radiographic apparatus according to claim 10, wherein when intervals in the second direction between the radiation shield units neighboring to each other of the respective first and second grating units are respectively d1 and d2, a following equation is satisfied.
d2={(L1+L2)/L1}×d1.

12. The radiographic apparatus according to claim 1, wherein the radiological image detector includes a conversion layer that converts the radiation into charges and a charge collection electrode that collects the charges converted by the conversion layer, for each pixel,
wherein the charge collection electrode has a plurality of linear electrode groups each of which consists of a plurality of linear electrodes, which are arranged with a pitch substantially coinciding with the pattern period of the radiological image and are electrically connected to each other,
wherein the linear electrode groups are arranged so that phases thereof are different from each other, and
wherein the grating pattern unit is configured by each of the linear electrode groups.

13. The radiographic apparatus according to claim 1, further comprising a radiation source for irradiating the radiation toward the first grating unit.

14. A radiographic system comprising:
the radiographic apparatus according to claim 1, and
a calculation processing unit that calculates, from an image detected by the radiological image detector of the radiographic apparatus, a distribution of refraction angles of the radiation incident onto the radiological image detector and generates a phase contrast image of a subject based on the distribution of the refraction angles.
